(19) United States
(12) Patent Application Publication
(10) Pub. No.: US 2021/0107495 A1
(43) Pub. Date: Apr. 15, 2021

(54) METHODS AND SYSTEMS FOR DETERMINING USERS' DRIVING HABITS AND PUSHING SERVICE INFORMATION

(71) Applicant: BEIJING DIDI INFINITY TECHNOLOGY AND DEVELOPMENT CO., LTD., Beijing (CN)

(72) Inventors: Gesi MENG, Hangzhou (CN); Min LI, Beijing (CN); Yu WANG, Beijing (CN); Shucan XIANG, Beijing (CN)

(73) Assignee: BEIJING DIDI INFINITY TECHNOLOGY AND DEVELOPMENT CO., LTD., Beijing (CN)

(21) Appl. No.: 17/131,796

(22) Filed: Dec. 23, 2020

Related U.S. Application Data
(63) Continuation of application No. PCT/CN2020/110439, filed on Aug. 21, 2020.

(30) Foreign Application Priority Data
Aug. 22, 2019 (CN) 201910777278.2

(51) Int. Cl. B60W 40/09; B60W 40/02; G06Q 30/06

(52) U.S. Cl. CPC B60W 40/09; B60W 40/02; B60W 2555/20; B60W 2556/10; B60W 2540/30; G06Q 30/0645

(57) ABSTRACT

The embodiments of the present disclosure disclose methods and systems for determining users' driving habits and pushing service information. The methods may include: obtaining a historical driving record of a user; extracting a driving feature of the user from the historical driving record; determining the driving habit of the user based on the driving feature of the user.

### CROSS-REFERENCE TO RELATED APPLICATIONS

This application is a continuation of International Application No. PCT/CN2020/110439 filed on Aug. 21, 2020, which claims priority of Chinese Patent Application No. 201910777278.2 filed on Aug. 22, 2019, the contents of each of which are incorporated herein by reference in their entirety.

### TECHNICAL FIELD

The present disclosure relates to the field of transportation service, and in particular, to methods and systems for determining a driving habit of a user and pushing service information.

### BACKGROUND

With the development of shared travel, vehicle sharing has come into people's life gradually. The fact that the vehicle sharing is becoming popular may reduce carbon emissions and people's parking troubles that makes more and more people choose the vehicle sharing for travel. Different users have different habits of driving a vehicle. In the prior art, user service information is pushed basically based on a real-time location of the user and real-time power consumption. As to the vehicle sharing, service information is basically pushed based on relevant information to the vehicle, but not the vehicle driving habits of different users.

### SUMMARY

An embodiment of the present disclosure provides a method for determining a driving habit of a user. The method may be executed by at least one processor. The method may include obtaining a historical driving record of the user; extracting a driving feature of the user from the historical driving record; and determining the driving habit of the user based on the driving feature of the user.

In some embodiments, the driving feature of the user may include at least one of a car accident incurred, a violation of a traffic rule, a sharp acceleration, a sharp turn, speeding, sudden braking, an average driving speed, and a lane change.

In some embodiments, the determining the driving habit of the user based on the driving feature of the user may include determining, based on the driving feature of the user, the driving habit of the user by using a trained driving habit determination model.

An embodiment of the present disclosure provides a method for pushing service information. The method may include determining a driving habit of a user according to the method for determining a driving habit of a user of any embodiment of the present disclosure; and pushing the service information to the user based on the driving habit of the user.

In some embodiments, the service information may include non-deductible service information of an order. The pushing service information to the user according to the driving habit of the user may include pushing non-deductible service price information of the order to the user based on the driving habit of the user.

In some embodiments, the pushing non-deductible service price information of the order to the user based on the driving habit of the user may include determining a loss rate of the order based on information related to the loss rate; determining the non-deductible service price of the order based on the loss rate of the order and the driving habit of the user; and displaying the non-deductible service price of the order to the user.

In some embodiments, the information related to the loss rate may include at least one of: order information, environmental information, a historical driving route, vehicle information, traffic information, road information, and user information.

In some embodiments, the order information may include at least one of: a starting point of the order, an ending point of the order, a duration of the order, and a planned driving route of the order.

In some embodiments, the environmental information may include at least one of: weather, a season, an outside temperature, a time, and a type of the time.

In some embodiments, the determining the loss rate of the order based on the information related to the loss rate may include determining, based on the information related to the loss rate, the loss rate of the order by using a trained order loss rate prediction model.

In some embodiments, the service information may include cruising mileage information. The pushing the service information to the user based on the driving habit of the user may include pushing the cruising mileage information of the vehicle to the user based on the driving habit of the user.

In some embodiments, the pushing the cruising mileage information of the vehicle to the user based on the driving habit of the user may include determining, based on the driving habit of the user and information related to the cruising mileage, the cruising mileage of the vehicle by using a trained cruising mileage prediction model; and displaying the cruising mileage of the vehicle to the user.

In some embodiments, the information related to the cruising mileage may include at least one of: environmental information, vehicle information, road information, and power information.

In some embodiments, the environmental information may include at least one of: weather, a season, an outside temperature, a time, and a type of the time.

In some embodiments, the vehicle information may include at least one of: a vehicle age, historical charging times of the vehicle, and a service life of a vehicle accessory.

An embodiment of the present disclosure provides a system for determining a driving habit of a user. The system may include a driving record obtaining module, a driving feature extraction module, and a driving habit determination module. The driving record obtaining module may be configured to obtain a historical driving record of the user. The driving feature extraction module may be configured to extract a driving feature of the user from the historical driving record. And the driving habit determination module may be configured to determine the driving habit of the user based on the driving feature of the user.

In some embodiments, the driving feature of the user may include at least one of: a car accident incurred, a violation of a traffic rule, a sharp acceleration, a sharp turn, speeding, sudden braking, an average driving speed, and a lane change.

In some embodiments, the driving habit determination module may be configured to determine, based on the driving feature of the user, the driving habit of the user by using a trained driving habit determination model.

An embodiment of the present disclosure provides a system for pushing service information. The system may include a driving habit determination module and a service information pushing module. The driving habit determination module may be configured to determine a driving habit of a user according to the method for determining a driving habit of a user of any embodiment of the present disclosure. The service information pushing module may be configured to push service information to the user according to the driving habit of the user.

In some embodiments, the service information may include non-deductible service information of an order. The service information pushing module may include a non-deductible service information pushing unit. The non-deductible service information pushing unit may be configured to push the non-deductible service price information of the order to the user based on the driving habit of the user.

In some embodiments, the non-deductible service information pushing unit may be configured to determine a loss rate of the order based on information related to the loss rate; determine the non-deductible service price of the order based on the loss rate of the order and the driving habit of the user; and display the non-deductible service price of the order to the user.

In some embodiments, the information related to the loss rate may include at least one of: order information, environmental information, a historical driving route, vehicle information, traffic information, road information, and user information.

In some embodiments, the order information may include at least one of: a starting point of the order, an ending point of the order, a duration of the order, and a planned driving route of the order.

In some embodiments, the environmental information may include at least one of: weather, a season, an outside temperature, a time, and a type of the time.

In some embodiments, the non-deductible service information pushing unit may be configured to determine, based on the information related to the loss rate, the loss rate of the order by using a trained order loss rate prediction model.

In some embodiments, the service information may include cruising mileage information. The service information pushing module may include a cruising mileage information pushing unit. The cruising mileage information pushing unit may be configured to push the cruising mileage information of the vehicle to the user based on the driving habit of the user.

In some embodiments, the cruising mileage information pushing unit may be configured to determine, based on the driving habit of the user and information related to the cruising mileage, the cruising mileage of the vehicle by using a trained cruising mileage prediction model; and display the cruising mileage of the vehicle to the user.

In some embodiments, the information related to the cruising mileage may include at least one of: environmental information, vehicle information, road information, and power information.

In some embodiments, the environmental information may include at least one of: weather, a season, an outside temperature, a time, and a type of the time.

In some embodiments, the vehicle information may include at least one of: a vehicle age, historical charging times of the vehicle, and a service life of a vehicle accessory.

An embodiment of the present disclosure provides an apparatus including a processor. The processor may be configured to execute the methods of any embodiment of the present disclosure.

An embodiment of the present disclosure provides a computer-readable storage medium with computer instructions stored thereon. When executed by a computer, the computer instructions may direct the computer to execute the method of any embodiment of the present disclosure.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures, and wherein:

FIG. 1 is a flowchart illustrating an exemplary process of a method for determining a driving habit of a user and pushing service information according to some embodiments of the present disclosure;

FIG. 2 is a flowchart illustrating an exemplary process of a method for pushing non-deductible service information according to some embodiments of the present disclosure;

FIG. 3 is a flowchart illustrating an exemplary process of a method for pushing cruising mileage information according to some embodiments of the present disclosure; and

FIG. 4 is a block diagram of a system for determining a driving habit of a user and pushing service information according to some embodiments of the present disclosure.

### DETAILED DESCRIPTION

In order to explain the technical solutions of the embodiments of the present disclosure more clearly, the following will briefly introduce the drawings that need to be used in the description of the embodiments. Obviously, for those of ordinary skill in the art, the present disclosure can be applied to other similar scenarios according to these drawings without creative work. Unless obviously obtained from the context or the context illustrates otherwise, the same numeral in the drawings refers to the same structure or operation.

It should be understood that the “system”, “device”, “unit” and/or “module” used herein is a method for distinguishing different components, elements, parts, parts, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise. Generally speaking, the terms “comprising” and “including” only suggest that the clearly identified steps and elements are included, and these steps and elements do not constitute an exclusive list, and the method or device may also include other steps or elements.

A flowchart is used in the present disclosure to illustrate the operations performed by the system according to the embodiments of the present disclosure. It should be understood that the preceding or following operations are not necessarily performed exactly in order. Instead, the steps can be processed in reverse order or simultaneously. At the same time, other operations may also be added to these processes, or remove a step or several operations from these processes.

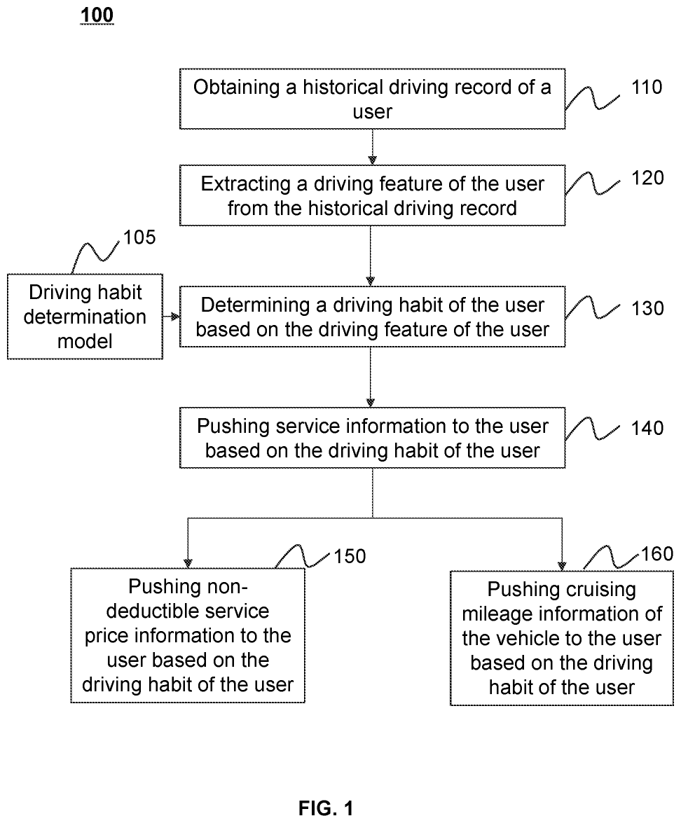

FIG. 1 is a flowchart illustrating an exemplary process of a method for determining a driving habit of a user and pushing service information according to some embodiments of the present disclosure. The method 100 for determining the driving habit of the user and pushing service information may be executed by the system 400 for determining the driving habit of the user and pushing service information. In the embodiment of the present disclosure, the system 400 for determining the driving habit of the user and pushing service information may be configured to execute the method for determining the driving habit of the user and/or the method for pushing service information. In some alternative embodiments, the method for determining the driving habit of the user and the method for pushing service information may also be respectively executed by one particular system (e.g., a system for determining the driving habit of the user, and a system for pushing service information). As shown in FIG. 1, the method 100 for determining a driving habit of a user and pushing service information may include:

In 110, a historical driving record of the user may be obtained. Specifically, operation 110 may be executed by the driving record obtaining module 410.

In some embodiments, the historical driving record may include a driving record of the user before the current use of the car, from the time starting using the vehicle to the current time, before the current time, or the like. In some embodiments, the historical driving record of the user may include, but is not limited to, a historical vehicle driving record, a historical violation record, a historical traffic accident record, a historical vehicle maintenance record of the user, or the like, or any combination thereof.

In some embodiments, the historical vehicle driving record of the user may include, but is not limited to, a historical vehicle driving trajectory record, a historical driving time record (e.g., daytime, night, driving duration, etc.), a historical vehicle operation record of the user (e.g., a sharp acceleration, a sharp deceleration, a sharp turn, etc.), or the like, or any combination thereof. In some embodiments, the historical violation record of the user may include, but is not limited to, a historical parking violation record, a historical speeding record, a historical overtaking record, a historical overload record of the user, or the like, or any combination thereof. In some embodiments, the historical vehicle driving record of the user may be a historical driving record of the user driving a shared vehicle. In some embodiments, the historical vehicle driving record of the user may also include a driving record of the user driving other vehicles (e.g., a private vehicle). In some embodiments, the historical traffic accident record of the user may include, but is not limited to, a count of traffic accidents, types of the traffic accidents, occurrence time of the traffic accidents, liable persons of the traffic accidents, or the like. In some embodiments, the historical vehicle maintenance record may include, but is not limited to, a count of vehicle maintenances, a category of the vehicle maintenances, and time of the vehicle maintenances.

In some embodiments, the historical driving record of the user may also include a driving age, a vehicle driving mileage, a vehicle purchase order of the user and other data records related to vehicle driving of the user. In some embodiments, the historical driving record of the user may also include a driving mileage and driving time in a single trip, a driving time in the day, driving speed at a certain moment, or the like. In some embodiments, the historical driving record of the user may also include a frequency of the user using a vehicle, whether turning on a turn signal when turning, using a high beam, or the like. In some embodiments, the historical driving record of the user may also include the user's detailed record of related data of a vehicle driving. Taking a single sharp acceleration made by the user as an example, the single sharp acceleration of the user may include information such as the location, time, and road condition when the sharp acceleration occurred.

In some embodiments, the driving record obtaining module 410 may obtain the historical driving record of the user from a vehicle rental platform. For example, the driving record obtaining module 410 may obtain a vehicle driving record, a violation record, etc. from the historical orders of the user on the vehicle rental platform. The vehicle rental platform may include, but is not limited to, a vehicle sharing platform, a vehicle rental APP, a vehicle rental PC client, a vehicle rental agency, or the like. In some embodiments, the driving record obtaining module 410 may obtain the historical driving record of the user from a user client terminal (e.g., a mobile phone). For example, the driving record obtaining module 410 may obtain the historical vehicle driving record of the user from historical positioning data of the user client terminal. In some embodiments, the driving record obtaining module 410 may obtain the historical driving record of the user from a network database. For example, the driving record obtaining module 410 may obtain the historical violation record of the user via a city violation query at the city official website, a violation query APP, etc. via the network. In some embodiments, the driving record obtaining module 410 may obtain the historical driving record of the user from relevant bill information. For example, the driving record obtaining module 410 may obtain the vehicle maintenance record using a vehicle maintenance order of the user, and may obtain the vehicle violation record of the user according to the violation ticket received by the user. In some embodiments, the driving record obtaining module 410 may obtain the historical driving record of the user from a vehicle-mounted device. For example, the driving record obtaining module 410 may obtain the historical vehicle driving record of the user from a driving recorder. In some embodiments, the driving record obtaining module 410 may obtain the historical driving record of the user from a navigation device. For example, the driving record obtaining module 410 may obtain the historical vehicle driving trajectory record of the user from a navigation map. In some embodiments, the driving record obtaining module 410 may automatically obtain a required historical driving record via an application interface (API). A count of APIs is not limited here.

In 120, a driving feature of the user may be extracted from the historical driving record. Specifically, operation 120 may be performed by the driving feature extraction module 420. In some embodiments, the driving feature of the user may include, but is not limited to, a car accident incurred, a violation of a traffic rule, a sharp acceleration, a sharp turn, speeding, sudden braking, an average driving speed, a maximum driving speed, a lane change, a fatigue driving, or the like, or any combination thereof.

In some embodiments, the driving feature extraction module 420 may extract driving features such as the sharp acceleration, the sharp turn, the sudden braking, the average driving speed, the maximum driving speed, the lane change, the fatigue driving, etc. based on the historical vehicle driving record of the user. In some embodiments, the driving feature extraction module 420 may extract the driving feature of the user based on a threshold. For example, a driving time threshold may be set in the system. When the driving time of the user for a day exceeds the threshold, it is considered that the user has a fatigue driving. As another example, a speed threshold may be set in the system. When the driving speed difference of the user between two consecutive moments exceeds the speed threshold, it is considered that the user has a sudden acceleration. In some embodiments, the driving feature extraction module 420 may extract the driving feature of the user based on data calculation. For example, the system may calculate and obtain the average driving speed of the user based on a driving mileage and driving time in a trip of the user. In some embodiments, the driving feature extraction module 420 may determine the driving feature of the user based on data statistics. For example, the sharp acceleration of the user may include an accumulated count of sharp accelerations of the user, a count of sharp accelerations per unit time, and a sharp acceleration frequency. The driving features such as the encountered car accident, the violation of a traffic rule, the sharp turn, the speeding, the sudden braking, etc. may also be determined according to similar statistical methods.

In some embodiments, the driving feature extraction module 420 may extract the driving features such as the encountered car accident, the violation of a traffic rule, the speeding based on the historical violation record, the historical traffic accident record, and the historical vehicle maintenance record of the user. For example, the system may directly extract the violation of a traffic rule, the speeding, etc. from the violation record of the user. As another example, the system may obtain the encountered traffic accident of the user by analyzing the historical vehicle maintenance record and the historical traffic accident record of the user.

In some embodiments, the driving feature extraction module 420 may also extract the driving feature from the historical driving record of the user by using a driving feature extraction model. In some embodiments, the driving feature extraction model may include a statistical analysis model, a machine learning model, a deep learning model, or the like. For example, the driving feature extraction model may include, but is not limited to, a Linear Regression (LR) model, a Variance Analysis Model, a Convolutional Neural Networks (CNN) model, a Recurrent Neural Network (RNN) model, a Support Vector Machine (SVM) model, or the like, or any combination thereof.

In 130, the driving habit of the user may be determined based on the driving feature of the user. Specifically, operation 130 may be executed by the driving habit determination module 430.

In some embodiments, the driving habit of the user may be used to reflect personal characteristics of the user when driving a vehicle. In some embodiments, the driving habit of the user may be classified based on different factors. In some embodiments, the driving habit of the user may be divided into two or more categories. For example, the system may classify the driving habits into an aggressive type and a stable type based on a vehicle stability when the user drives the vehicle. As another example, the system may divide the driving habits of the user into a bile type (adventurous, driving aggressively, etc.), a mucus type (law-abiding, driving slowly, etc.), a depression type (obeying traffic regulations, susceptible to sudden braking, etc.), and a multi-blood type (driving unevenly, sometimes fast and sometimes slow, etc.) according to personalities used in the medical classification of people. As a further example, the system may divide the driving habits into a self-righteous type (experienced, violate occasionally), a peaceful type (driving slowly, courteous), a severe torture type (strictly complying with traffic laws), a stressful urgent type (braking repeatedly), a road rage type (driving fast), or the like.

In some embodiments, the driving habit determination module 430 may determine the driving habit of the user by using a trained driving habit determination model 105. In some embodiments, the driving habit determination model 105 may include a machine learning model. For example, the driving habit determination model 105 may include, but is not limited to, a K nearest neighbor algorithm (KNN), a perceptron model, a naive Bayes model, a decision tree model, a logistic regression model, a Support Vector Machine (SVM), a random forest model, a neural network model, or the like, or any combination thereof. In some embodiments, the driving habit determination model 105 may determine a type of driving habit to which the user belongs based on the driving feature of the user. In such cases, the driving habit determination model 105 may directly output a classification result of the driving habit of the user and/or a score corresponding to the type of driving habit. In some embodiments, the driving habit determination model 105 may directly determine the driving habit of the user score based on the driving feature of the user. For example, the driving habit determination model 105 may score the driving habit of the user from 0 to 10 according to a safety level of vehicle driving of the user. The higher the score, the better the driving habit of the user, and the less likely a traffic accident may occur.

In some embodiments, the driving habit determination model 105 may be obtained according to a training process based on sample data. The sample data may include driving features of a plurality of users and their corresponding driving habits. The driving features of the plurality of users may be extracted from historical driving records by the driving feature extraction module 420. The driving habits corresponding to the plurality of users may be determined by manual labeling. For example, a staff may artificially determine a driving habit of a user based on one or more types of information such as a driving feature of the user, a historical driving record of the user, and personality characteristics of the user. In some embodiments, the sample data may be labeled by using models and/or machines. In some embodiments, the driving feature extraction model and the driving habit determination model 105 may be a model that has both a driving feature extraction function and a driving habit determination function, or two different models that have a driving feature extraction function and a driving habit determination function, respectively.

In some embodiments, the driving habit determination module 430 may also determine the driving habit of the user by using other methods (e.g., based on rules). For example, the driving habit determination module 430 may determine, by setting a threshold based on the driving feature of the user, the driving habit of the user whose count of sharp acceleration (and/or sharp turn, sudden braking, etc.) is larger than a threshold (e.g., a frequency) as an aggressive type, and determine the driving habit of the user whose count of sharp acceleration (and/or sharp turn, sudden braking, etc.) is less than the threshold as a stable type, thereby determining the driving habit of the user.

In some embodiments, the driving habit of the user may be used to predict a probability of a traffic accident of the user, analyze a cause of the traffic accident, and select users who need safety education. For example, a system (e.g., the system 400 for determining a driving habit of a user and pushing service information) may monitor and prompt a user when it predicts that the user is more likely to have a traffic accident, so as to reduce an accident rate. As another example, when the driving habit of the user belongs to an aggressive type, the system may send videos, audios or texts related to safe travel to educate/guide the user. In some embodiments, the system may push personalized service information to the user based on the driving habit of the user. More details regarding the service information push may be found in operations 140-160 and descriptions thereof.

In some alternative embodiments, the historical driving record of the user may include whether there has been a vehicle maintenance and a maintenance frequency after the user uses a vehicle, whether there has been a vehicle repair and a repair frequency after the user uses the vehicle, whether there was garbage left in the vehicle after use (a usage habit of a previous user may be determined according to an evaluation of environment in the vehicle or direct feedback of a next user), a parking position of the vehicle after use, whether there is a traffic accident when the user uses the vehicle, or the like, or any combination thereof. The driving habit of the user may include a responsibility degree of the user. For example, the driving habit of the user may include “responsible” and “irresponsible”. The sample data may be labeled as “responsible” or “irresponsible” manually or using a model based on the historical driving record of the user. For example, after the user uses a vehicle, if a parking position of the vehicle meets the regulations and the vehicle is clean and free of garbage, the user may be considered to be “responsible”. As another example, if a user does not meet the requirements of any of the “responsible” items, the user may be considered to be irresponsible and the sample data may be labeled as “irresponsible”. The sample data may be labeled as “responsible” only when all the requirements of the “responsible” items are met. In some embodiments, the driving habit determination model 105 may be a supervised machine learning model. For example, labeled sample data may be input into the supervised machine learning model (the driving habit determination model 105) for training to generate a responsibility evaluation model. The responsibility evaluation model may evaluate whether a user is responsible. In some embodiments, the responsibility evaluation model may extract a feature based on the sample data. For example, the responsibility evaluation model may extract driving characteristics based on historical driving records, such as converting the sample data into characteristic values by using a self-defined rule. For example, taking the violation of a traffic rule of a user as an example, 0-3 times of violation may proportionally correspond to [0, 0.6], 3-6 times of violation may proportionally correspond to [0.6, 1], and 6 or more times of violation may proportionally correspond to 1. As another example, a self-defined continuous function may be used to convert the sample data into characteristic values. Taking a violation of a traffic rule by a user as an example, sigmoid (a violation situation of a traffic rule of the user) may be used as a characteristic value of the violation of a traffic rule of the user. As another example, the sample data may be converted into feature vectors in a bucketing manner. In some embodiments, historical data in a certain period of time may be combined for a calculation to obtain characteristic values representing historical conditions. For example, the combined calculation may be: 0.9*t1+0.8*t2+0.7*t3+ . . . , where t1, t2, . . . in turn are data at different time points from near to far.

In 140, service information may be pushed to the user according to the driving habit of the user. Specifically, operation 140 may be performed by the service information pushing module 440.

In some embodiments, the service information may include related services that are provided and/or pushed to the user to meet the user's needs according to user settings. In some embodiments, the service information may include, but is not limited to, a non-deductible service, a vehicle cruising mileage push service, a vehicle sharing push service, a vehicle sale push service, a navigation route push service, a vehicle insurance push service, or the like, or any combination thereof.

In some embodiments, the service information pushing module 440 may push different types of service information to the user according to requirements of the user. The following will take the non-deductible service and the vehicle cruising mileage push service as examples for illustration.

In 150, non-deductible service price information of an order may be pushed to the user according to the driving habit of the user. Specifically, operation 150 may be performed by the non-deductible service information pushing unit 442.

Non-deductible refers to “a special clause without deductible ratio”. It is a kind of additional insurance, which means that after an insurance event occurs, the insurer shall be responsible for the deductible amount. The deductible amount may be calculated according to a deductible rate stipulated in the main insurance clause of the insurance and should be paid by the insured. In some embodiments, applicable insurance types of non-deductible may include a third-party liability insurance, a motor vehicle loss insurance, a personnel liability insurance, a body scratch damage insurance, a robbery and burglary insurance, or the like, or any combination thereof.

In some embodiments, a probability of an accident when the user drives the vehicle may be related to the driving habit of the user. For example, a user with a stable driving habit may be less likely to have a traffic accident, and a user with an aggressive driving habit may be more likely to have a traffic accident. Therefore, more reasonable non-deductible service options may be provided to users by determining the non-deductible service price based on the driving habit of the user.

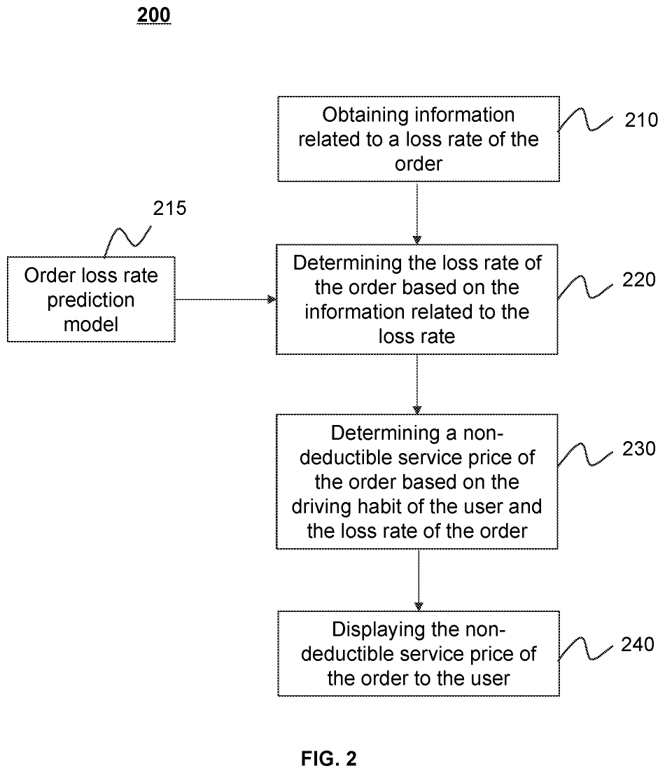

In some embodiments, the non-deductible service information pushing unit 442 may determine a loss rate of the order based on information related to the loss rate. In some embodiments, the non-deductible service information pushing unit 442 may determine the non-deductible service price of the order based on the driving habit of the user and the loss rate of the order, and display the non-deductible service price of the order to the user. More details regarding pushing information related to non-deductible service may be found in FIG. 2 and descriptions thereof.

In 160, cruising mileage information of the vehicle may be pushed to the user according to the driving habit of the user. Specifically, operation 160 may be performed by the cruising mileage information pushing unit 444.

In some embodiments, the cruising mileage of the vehicle may be used to reflect the mileage that the vehicle may drive (or continue to drive). In some embodiments, the cruising mileage of the vehicle may be used to reflect a cruising mileage of the vehicle before driving, a cruising mileage of the vehicle during driving, a cruising mileage of the vehicle after the driving is completed, or the like. In some embodiments, the cruising mileage of the vehicle may be related to the driving habit of the user. For example, a vehicle driven by a user with an aggressive driving habit may has higher fuel consumption when driving a vehicle, and the cruising mileage of the vehicle may be relatively low.

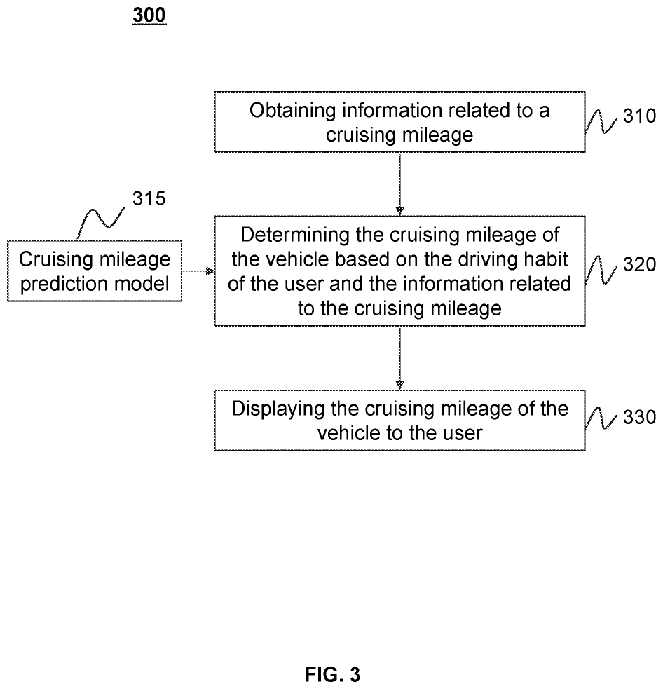

In some embodiments, the cruising mileage information pushing unit 444 may determine the cruising mileage of the vehicle based on the driving habit of the user and information related to the cruising mileage, and display the cruising mileage of the vehicle to the user. In some embodiments, the cruising mileage information pushing unit 444 may also determine the cruising mileage of the vehicle based only on the information related to the cruising mileage. In some embodiments, the cruising mileage information pushing unit 444 may determine the cruising mileage of the vehicle using a cruising mileage prediction model 315. More details regarding pushing the cruising mileage information may be found in FIG. 3 and descriptions thereof.

In some embodiments, the service information pushing module 440 may push different types of shared vehicles to the user based on the driving habit of the user. For example, a user with an aggressive driving habit may consume more fuel when driving a vehicle. A shared vehicle that consumes less fuel or power may be pushed to the user. A user with a stable driving habit may have a high safety factor when driving a vehicle. A shared vehicle with a high user praise rate and/or a high user usage rate may be pushed to the user.

In some embodiments, the service information pushing module 440 may push the shared vehicle to the user based on the driving habit of the user and rental information of the user. In some embodiments, the rental information of the user may include, but is not limited to, a rental duration, a rental time, a travel plan, or the like, or any combination thereof. In some embodiments, the rental information of the user may include rental information input by the user via a client terminal of a shared vehicle, history rental information of the user, or the like, or any combination thereof. In some embodiments, the service information pushing module 440 may determine a rental requirement of the user based on the driving habit of the user and the rental information of the user, and then push a shared vehicle that meets the rental requirement to the user. For example, for a user with a stable driving habit who needs to rent a vehicle for long rental time to travel a long distance, it may be determined that the user may need a shared vehicle with a large cruising mileage, and such a shared vehicle may be pushed to the user.

In some embodiments, the service information pushing module 440 may push the shared vehicle to the user based on the driving habit of the user and personal information of the user. In some embodiments, the personal information of the user may include, but is not limited to, a gender, an age, a personality, a driving experience, a personal preference (e.g., color, etc.), a consumption level of the user, or the like, or any combination thereof. For example, for a user with a stable driving habit and personal information such as a female, a preference for red, a short driving experience, a high consumption level, etc., a shared vehicle in red color and having a high safety performance (e.g., a sensitive braking, high elastic airbag, etc.) may be pushed to the user. As another example, for a user with a stable driving habit and personal information such as a long driving experience and a low consumption level, a shared vehicle with a lower rental price may be pushed to the user. In some alternative embodiments, the service information pushing module 440 may push the shared vehicle to the user based on one or more of the driving habit of the user, the rental information of the user, the personal information of the user, etc., which is not limited in the present disclosure.

In some embodiments, the service information pushed by the service information pushing module 440 may include information about one or more shared vehicles. In some embodiments, the information of the shared vehicle may include, but is not limited to, a location, a color, a vehicle model, a performance parameter, a power or fuel consumption, a rental price, a picture of the shared vehicle, or the like, or any combination thereof.

In some embodiments, a trained shared vehicle pushing model may be used to determine the shared vehicle to be pushed to the user. For example, inputs of the shared vehicle pushing model may be the driving habit of the user, the rental information of the user, and the personal information of the user, and outputs may be pushable shared vehicle and/or information of the shared vehicle. In some embodiments, the shared vehicle pushing model may include a machine learning model. For example, the shared vehicle pushing model may include, but is not limited to, an LR model, a logistic regression model, a polynomial regression model, a stepwise regression model, a ridge regression model, a lasso regression model, an elastic regression model, a neural network model, or the like, or any combination thereof.

In some embodiments, the service information pushing module 440 may push a vehicle for sale to the user based on the driving habit of the user.

In some embodiments, the vehicle for sale may include a second-hand vehicle and/or a brand-new vehicle. In some embodiments, the service information pushing module 440 may push the vehicle for sale to the user based on the driving habit of the user and the personal information of the user. For example, for a user with a stable driving habit and personal information such as a female, a preference for red, a short driving experience, a high consumption level, etc., a vehicle for sale in red color and having a high safety performance (e.g., a sensitive braking, a high elastic airbag, etc.) may be pushed to the user. As another example, for a user with a stable driving habit and personal information such as a long driving experience, a low consumption level, etc., a second-hand vehicle with a high price/performance ratio may be pushed to the user. The price/performance ratio of a vehicle for sale may be a ratio of the price of the vehicle to the performance of the vehicle. In some embodiments, the performance of the vehicle may include, but is not limited to, a fuel/power consumption of the vehicle, a situation of a vehicle accessory, or the like.

In some embodiments, the pushing service of the vehicle for sale may include push of sale information of one or more vehicles. In some embodiments, the information of the vehicle for sale may include, but is not limited to, a color of the vehicle, a vehicle model, a performance parameter, a power or fuel consumption, a price, a picture, or the like, or any combination thereof. In some embodiments, when the pushed vehicle for sale is a second-hand vehicle, the information of the vehicle for sale may also include a vehicle age, a count of historical charging/refueling of the vehicle, a count of vehicle maintenances, a count of vehicle repairs, a life of a vehicle accessory, whether the vehicle is involved in a traffic accident, resale times of vehicle the vehicle, or the like, or any combination thereof.

In some embodiments, the service information pushing module 440 may push a navigation route to the user based on the driving habit of the user.

In some embodiments, the service information pushing module 440 may push the navigation route to the user based on a type of the driving habit. For example, if the driving habit of the user is a road rage type (driving fast), a highway or a route with fewer vehicles may be pushed to the user. If the driving habit of the user is a stressful urgent type (braking repeatedly), a route with fewer detours may be pushed to the user. If the driving habit of the user is a self-righteous type (experienced, violate occasionally), a route with fewer traffic lights may be pushed to the user.

In some embodiments, the service information pushing module 440 may push the navigation route to the user based on the driving habit of the user and travel information of the user. In some embodiments, the travel information may include, but is not limited to, a starting point and an ending point of the travel, travel time, a travel purpose, or the like, or any combination thereof. For example, for a user with a driving habit of a self-righteous type who travels for a meeting at a peak period, a navigation route with fewer vehicles and a shorter travel distance may be pushed to the user.

In some embodiments, a trained navigation route determination model may be used to push the navigation route. For example, inputs of the model may be the driving habit of the user and/or the travel information user, and outputs of the model may be one or more pushable navigation routes. In some embodiments, the navigation route determination model may include a machine learning model. For example, the navigation route determination model may include, but is not limited to, an LR model, a logistic regression model, a polynomial regression model, a stepwise regression model, a ridge regression model, a lasso regression model, an elastic regression model, a neural network model, or the like, or any combination thereof. In some embodiments, the navigation route determination model may be obtained according to a training process based on sample data.

In some embodiments, the service information pushing module 440 may push the navigation route to the user using a page display, picture display, a window display (e.g., a circular window, a rectangular window, a triangular window or other shapes of pop-up windows), a link display (e.g., a link that can jump to a navigation route), a text display, or the like, or any combination thereof.

In some embodiments, the service information pushing module 440 may push vehicle insurance information to the user based on the driving habit of the user.

Motor vehicle insurance, namely vehicle insurance, refers to a type of insurance that compensates for personal injury or property damage caused by the vehicle due to a natural disaster or an accident. In some embodiments, the vehicle insurance may include, but is not limited to, a compulsory traffic insurance, a vehicle loss insurance, a third-party liability insurance, a robbery and burglary insurance, a scratch insurance, a separate glass breakage insurance, a spontaneous combustion insurance, a non-deductible insurance, or the like. For example, the compulsory traffic insurance may be a compulsory liability insurance in which an insurance company compensates for a personal injury and property loss of a victim (excluding vehicle personnel and the insured) caused by a traffic accident of the insured vehicle within the liability limit. The vehicle loss insurance may be an insurance for bodies of various motor vehicles and their accessories, equipment, etc. If the insured vehicle suffers from a natural disaster or an accident within a scope of the insurance liability and causes loss of the insured vehicle, the insurer may pay compensation in accordance with the provisions of the insurance contract. The third-party liability insurance may be an amount of compensation that the insured should pay for a direct personal injury and property loss of the third party when an accident occurs during a usage of the insured vehicle by the insured or its permitted qualified driver.

In some embodiments, the probability of an accident when the user drives the vehicle may be related to the driving habit of the user. For example, a user with a stable driving habit may be less likely to have a traffic accident, and a user with an aggressive driving habit may be more likely to have a traffic accident. Better protection for driving and/or traveling may be provided to the user by pushing the vehicle insurance to the user based on the driving habit of the user. For example, if the driving habit of the user is a mucus type (law-abiding, driving slowly, etc.), a robbery and burglary insurance, a spontaneous combustion insurance, etc. may be pushed to the user. If the driving habit of the user is a bile type (adventurous, driving aggressively, etc.), a third-party liability insurance, a vehicle loss insurance, etc. may be pushed to the user.

In some embodiments, the service information pushing module 440 may push the vehicle insurance to the user based on the driving habit of the user and a loss rate. In some embodiments, the loss rate may include, but is not limited to, a historical loss rate and/or a current loss rate of the user. The historical loss rate may be a proportion of vehicle accidents in a historical driving of the user. The current loss rate may be a probability of a vehicle accident occurring during a current driving of the user. In some embodiments, the current loss rate of the user may be determined based on the driving habit of the user. In some embodiments, the vehicle accident may include, but is not limited to, a vehicle scratch, a vehicle collision, or the like, or any combination thereof. In some embodiments, the loss rate may be determined by using a mathematical statistic, a machine learning model, or the like. For example, the historical loss rate may be determined by using a mathematical statistic, or the current loss rate may be determined using a trained machine learning model.

In some embodiments, for a user with a stable driving habit and a low loss rate (e.g., less than a preset threshold), a compulsory traffic insurance may be pushed to the user. In some embodiments, for a user with a stable driving habit and a high loss rate, one or more of a compulsory traffic insurance, a vehicle loss insurance, a third-party liability insurance, a separate glass breakage insurance, a non-deductible insurance, etc. may be pushed to the user. In some embodiments, for a user with an aggressive driving habit, the loss rate may be ignored, and the compulsory traffic insurance, the vehicle loss insurance, the third-party liability insurance, the separate glass breakage insurance, the non-deductible insurance may be pushed to the user directly.

In some embodiments, the service information pushing module 440 may push the vehicle insurance information to the user based on the driving habit of the user, the loss rate, and/or the personal information of the user. For example, for a user with an aggressive driving habit, a high loss rate, and a low consumption level, the traffic compulsory insurance, the vehicle loss insurance, and the third-party liability insurance may be pushed to the user. For a user with an aggressive driving habit, a high loss rate, and a high consumption level, the compulsory traffic insurance, the vehicle loss insurance, the third-party liability insurance, the separate glass breakage insurance, and the non-deductible insurance may be pushed to the user. In some embodiments, the pushing of the vehicle insurance may include, but is not limited to, one or more of the vehicle insurance, an insured amount, a compensation amount, a compensation clause, or the like.

It should be noted that the description of the process 100 is only for example and description, and does not limit the scope of application of the present disclosure. For those skilled in the art, various modifications and changes can be made to the process 100 under the guidance of the present disclosure. However, these amendments and changes are still within the scope of the present disclosure. For example, the extraction of the driving feature of the user in operation 120 may be omitted, and the driving habit of the user may be determined directly based on the historical driving record of the user. As another example, operation 120 and operation 130 may be performed synchronously, that is, the system 400 for determining a driving habit of a user and pushing service information may simultaneously perform the extraction of the driving feature of the user and the determination of the driving habit of the user.

FIG. 2 is a flowchart illustrating an exemplary process of a method for pushing non-deductible service information according to some embodiments of the present disclosure. The method 200 for pushing non-deductible service information may be performed by the system 400 (e.g., the non-deductible service information pushing unit 442) for determining the driving habit of the user and pushing service information. As shown in FIG. 2, the method 200 for pushing non-deductible service information may include:

In 210, information related to a loss rate of an order may be obtained.

In some embodiments, the order may be an order of the user to rent a vehicle (e.g., shared vehicle). In some embodiments, the information related to the loss rate may include, but is not limited to, order information, environmental information, historical driving route information, vehicle information, traffic information, road information, user information, or the like, or any combination thereof. In some embodiments, the order information may include, but is not limited to, a time when the order occurred (e.g., a peak travel period, a flat peak period; day, night, etc.), a starting point of the order, an ending point of the order, a duration of the order, a planned driving route of the order, or the like, or any combination thereof. In some embodiments, the environmental information may include, but is not limited to, weather (e.g., snow, rain, haze, etc.), a season (e.g., spring, summer, etc.), an outside temperature, a time, a type of the time (e.g., a working day, a rest day, a holiday, etc.), or the like, or any combination thereof. In some embodiments, the vehicle information may include, but is not limited to, a vehicle performance (e.g., a braking system), a vehicle age, a vehicle maintenance status (e.g., a count of maintenances), or the like, or any combination thereof. In some embodiments, the traffic information may include, but is not limited to, traffic light information, speed limit information, parking violation information, or the like, or any combination thereof. In some embodiments, the road information may include, but is not limited to, a road type (e.g., a low-speed road, a high-speed road), a road condition (e.g., flat, muddy, etc.), road traffic information (e.g., congestion), a road hazard (e.g., a winding road), or the like, or any combination thereof. In some embodiments, the user information may include, but is not limited to, a gender, an age, a personality, driving experience, a historical loss situation, a familiarity with the road, or the like, or any combination thereof.

In 220, the loss rate of the order may be determined based on the information related to the loss rate.

In some embodiments, the loss rate may be used to reflect a probability of a user having a vehicle accident in the order. In some embodiments, the vehicle accident may include, but is not limited to, a vehicle scratch, a vehicle collision, or the like, or any combination thereof.

In some embodiments, the non-deductible service information pushing unit 442 may determine the loss rate of the order by using a trained order loss rate prediction model 215. In some embodiments, the order loss rate prediction model 215 may include a statistical analysis model, a machine learning model, a deep learning model, or the like. For example, the order loss rate prediction model 215 may include, but is not limited to, an LR model, an analysis of variance model, a CNN model, an RNN model, an SVM model, or the like, or any combination thereof. In some embodiments, the order loss rate prediction model 215 may be trained based on historical order data. In some embodiments, the historical order data may include information related to a loss rate of a historical order. In some embodiments, a label of the historical order may be whether a loss occurred in the order. In some alternative embodiments, for historical orders with a loss, the label may further include a loss type. In some embodiments, the order loss rate prediction model 215 may predict, based on information related to the loss rate of the order, whether a loss may occur in the order. In some embodiments, the order loss rate prediction model 215 may predict, based on information related to the loss rate of the order, a probability value that a loss may occur in the order. In such cases, the non-deductible service information pushing unit 442 may further classify the loss rate of the order by setting a threshold. For example, the loss rate may be divided into three levels: a high level, a medium level, and a low level. For example, when the predicted probability value of a loss of an order is larger than a preset threshold, the non-deductible service information pushing unit 442 may determine that the level of loss rate of the order is high.

In some alternative embodiments, the non-deductible service information pushing unit 442 may determine the loss rate of the order by using other ways (e.g., based on rules). For example, the non-deductible service information pushing unit 442 may determine, based on information related to the loss rate and according to set rules, different levels of the loss rate. For example, a situation with a high road risk and order time in night may be determined to have a high loss rate.

In 230, a non-deductible service price of the order may be determined based on the driving habit of the user and the loss rate of the order. The non-deductible service price may refer to the cost that users need to pay for purchasing the non-deductible service.

In some embodiments, the non-deductible service information pushing unit 442 may determine the non-deductible service price of the order based on an order loss rate level and a type of the driving habit of the user. For example, the order loss rate level may include three levels: a high level, a medium level, and a low level. The type of the driving habit of the user may include an aggressive type and a stable type. When the driving habit of the user is aggressive, and the level of the order loss rate is high, medium, and low, respectively, the non-deductible service information pushing unit 442 may determine the non-deductible service price as 6 yuan, 5 yuan, 4 yuan, respectively. When the type of the driving habit of the user is stable, and the level of the order loss rate is high, medium, and low, respectively, the non-deductible service information pushing unit 442 may determine the non-deductible service price as 4 yuan, 3 yuan, and 2 yuan, respectively. In some embodiments, the non-deductible service information pushing unit 442 may determine the non-deductible service price for the user using different rules for dividing order loss rate (or using order loss probability values) and different classification rules for classifying the driving habit of the user according to a specific situation. In some embodiments, the non-deductible service information pushing unit 442 may also adjust an amount of the non-deductible service price according to the specific situation, which is not limited in the present disclosure.

In some alternative embodiments, the non-deductible service information pushing unit 442 may determine the non-deductible service price of the order based only on the order loss rate. In some alternative embodiments, the non-deductible service information pushing unit 442 may also determine the non-deductible service price based only on the driving habit of the user.

In 240, the non-deductible service price of the order may be displayed to the user.

In some embodiments, the non-deductible service information pushing unit 442 may display the non-deductible service price of the order to the user. In some embodiments, the non-deductible service information pushing unit 442 may display the non-deductible service price of the order to the user using various methods. For example, the display methods may include a page display, a picture display, a window display (e.g., a circular window, a rectangular window, a triangular window or other shapes of pop-up windows), a link display (e.g., a link that can jump to a purchase page of a non-deductible service), a text display, or the like, or any combination thereof.

In some embodiments, the non-deductible service information pushing unit 442 may display the non-deductible service price of the order to the user after the user initiates a rental order of a shared vehicle and before the vehicle starts. In some embodiments, the non-deductible service information pushing unit 442 may display the non-deductible service price of the order to the user before the user enters a rental page of the shared vehicle and before the order is initiated. In some embodiments, the non-deductible service information pushing unit 442 may push other information related to the non-deductible service such as a non-deductible service term, a deductible price, protection items, etc. to the user.

It should be noted that the description of the process 200 is only for example and description, and does not limit the scope of the present disclosure. For those skilled in the art, various modifications and changes may be made to the process 200 under the guidance of the present disclosure. However, these amendments and changes are still within the scope of the present disclosure. For example, in operation 220, the loss rate of the order may be determined based on the driving habit of the user.

FIG. 3 is a flowchart illustrating an exemplary process of a method for pushing cruising mileage information according to some embodiments of the present disclosure. The method 300 for pushing cruising mileage information may be performed by the system 400 (e.g., the cruising mileage information pushing unit 444) for determining a driving habit of a user and pushing service information. As shown in FIG. 3, the method 300 for pushing cruising mileage information may include:

In 310, information related to a cruising mileage may be obtained.

In some embodiments, the information related to the cruising mileage may include, but is not limited to, environmental information, vehicle information, traffic information, road information, power information, or the like, or any combination thereof. In some embodiments, the environmental information may include, but is not limited to, weather (e.g., snow, rain, haze, etc.), a season (e.g., spring, summer, etc.), an outside temperature, a time, a type of the time (e.g., a working day, a rest day, a holiday, etc.), or the like, or any combination thereof. In some embodiments, the vehicle information may include, but is not limited to, a vehicle model, a reference value of the vehicle cruising mileage (an initial cruising mileage value), a vehicle performance, vehicle historical maintenance times (e.g., refueling, charging, maintenance, etc.), a vehicle age, vehicle engine quality, or the like, or any combination thereof. In some embodiments, the road information may include, but is not limited to, a road type (e.g., a low-speed road, a high-speed road), a road condition (e.g., flat, muddy, etc.), road traffic information (e.g., congestion), a road hazard (e.g., a winding road), or the like, or any combination thereof. In some embodiments, when the vehicle is not an electric vehicle or a pure electric vehicle, the information related to the cruising mileage may also include fuel quantity information, gas quantity (e.g., a natural gas, a hydrogen) information, or the like.

In 320, the cruising mileage of the vehicle may be determined based on the driving habit of the user and information related to the cruising mileage. The cruising mileage of a vehicle may be used to reflect a distance that the vehicle can drive under the current power (or fuel, gas, etc.).

In some embodiments, the cruising mileage information pushing unit 444 may determine, based on the driving habit of the user and information related to the cruising mileage, the cruising mileage of the vehicle by using a trained cruising mileage prediction model 315. In some embodiments, the cruising mileage prediction model 315 may include a machine learning model. For example, the cruising mileage prediction model 315 may include, but is not limited to, an LR model, a logistic regression model, a polynomial regression model, a stepwise regression model, a ridge regression model, and a lasso regression model, an ElasticNet regression model, a neural network model, or the like, or any combination thereof.

In some embodiments, the cruising mileage prediction model 315 may be obtained according to a training process based on sample data. In some embodiments, the sample data may include the driving habit of the user, information related to the cruising mileage, and actual cruising mileages in a plurality of historical orders. The driving habit of the user in the historical orders may be determined by the driving habit determination module 430. The information related to the cruising mileage in the historical orders may be related information of the vehicle at a certain time point (or a certain period of time) in a driving process obtained by the cruising mileage information pushing unit 444. The actual cruising mileages in the historical orders may be determined according to an actual driving distance of the vehicle. In some embodiments, the actual cruising mileages in the historical orders may be a sum of an actual cruising mileage of the vehicle and an estimated cruising mileage of remaining power after driving.

In some alternative embodiments, the cruising mileage information pushing unit 444 may also determine the cruising mileage of the vehicle based only on the information related to the cruising mileage. For example, when there is no driving habit information of the user, the cruising mileage information pushing unit 444 may input the information related to the cruising mileage of the vehicle into the cruising mileage prediction model 315 and obtain the cruising mileage of the vehicle. In some alternative embodiments, the cruising mileage information pushing unit 444 may also determine the cruising mileage of the vehicle by using other ways (e.g., based on rules).

In 330, the cruising mileage of the vehicle may be displayed to the user.

In some embodiments, the cruising mileage information pushing unit 444 may display an estimated vehicle cruising mileage to the user. In some embodiments, the cruising mileage information pushing unit 444 may display the cruising mileage of the vehicle to the user in various ways. For example, the cruising mileage information pushing unit 444 may display the cruising mileage of the vehicle to the user by sending an SMS, sending an APP notification message, prompting by a pop-up window, highlighting (e.g., font enlargement, color highlighting, etc.), prompting by voice, or the like, or any combination thereof. In some embodiments, the cruising mileage information pushing unit 444 may display the cruising mileage of the vehicle to the user before the vehicle drives. In some embodiments, the cruising mileage information pushing unit 444 may display the cruising mileage of the vehicle to the user when the vehicle is driving. In some embodiments, the cruising mileage information pushing unit 444 may display the cruising mileage of the vehicle to the user after the vehicle has finished driving. Displaying the cruising mileage of the vehicle to the user may help the user understand the condition of the vehicle, and take corresponding measures in time when the vehicle is abnormal (e.g., insufficient power, insufficient fuel, etc.). For example, when a vehicle is driving, a user may find a nearby driving pile/gas station to charge or refuel the vehicle in time to avoid vehicle breakdowns and a delay of the trip when he/she learns that the cruising mileage of the vehicle is low.

In some embodiments, the cruising mileage information pushing unit 444 may display other information related to the cruising mileage to the user, such as driving time of the vehicle, a nearby gas station/charging pile, or the like.

It should be noted that the description of the process 300 is only for example and description, and does not limit the scope of the present disclosure. For those skilled in the art, various modifications and changes can be made to the process 300 under the guidance of the present disclosure. However, these amendments and changes are still within the scope of the present disclosure. For example, when a user is driving a vehicle, the cruising mileage information pushing unit 444 may continuously update the driving habit of the user and/or information related to the cruising mileage, and may re-determine the cruising mileage of the vehicle based on the updated driving habit of the user and information related to the cruising mileage, and display the re-determined cruising mileage to the user.

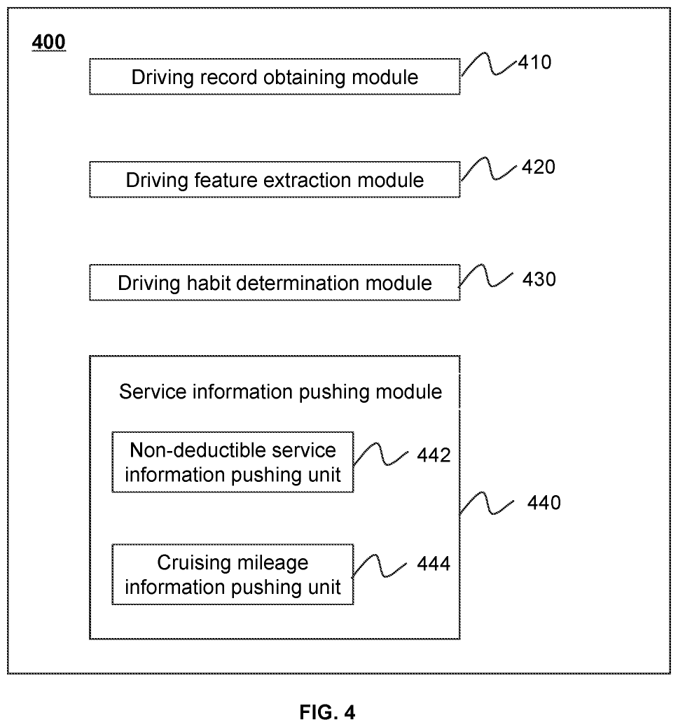

FIG. 4 is a block diagram of a system for determining a driving habit of a user and pushing service information according to some embodiments of the present disclosure. As shown in FIG. 4, the system 400 for determining the driving habit of the user and pushing service information may include a driving record obtaining module 410, a driving feature extraction module 420, a driving habit determination module 430, and a service information pushing module 440.

The driving record obtaining module 410 may be configured to obtain a historical driving record of a user. In some embodiments, the driving record obtaining module 410 may obtain the historical driving record of the user from a vehicle rental platform. In some embodiments, the driving record obtaining module 410 may obtain the historical driving record of the user from a user client terminal (e.g., a mobile phone). In some embodiments, the driving record obtaining module 410 may obtain the historical driving record of the user from a network database. In some embodiments, the driving record obtaining module 410 may obtain the historical driving record of the user from relevant bill information. In some embodiments, the driving record obtaining module 410 may obtain the historical driving record of the user from a vehicle-mounted device. In some embodiments, the driving record obtaining module 410 may obtain the historical driving record of the user from a navigation device.

The driving feature extraction module 420 may be configured to extract a driving feature of the user. In some embodiments, the driving feature extraction module 420 may extract the driving feature of the user from a historical driving record. In some embodiments, the driving feature extraction module 420 may extract driving features such as a sharp acceleration, a sharp turn, a sudden braking, an average driving speed, a maximum driving speed, a lane change, a fatigue driving based on historical vehicle driving record of the user. In some embodiments, the driving feature extraction module 420 may extract the driving feature of the user based on a threshold setting. In some embodiments, the driving feature extraction module 420 may extract the driving feature of the user based on a data calculation. In some embodiments, the driving features extraction module 420 may determine the driving feature of the user based on data statistics. In some embodiments, the driving feature extraction module 420 may also extract the driving feature from the historical driving record of the user by using a driving feature extraction model.

The driving habit determination module 430 may be configured to determine a driving habit of the user. In some embodiments, the driving habit determination module 430 may determine the driving habit of the user based on the driving feature of the user. In some embodiments, the driving habit determination module 430 may determine the driving habit of the user based on the driving feature of the user by using a trained driving habit determination model 105. In some embodiments, the driving habit determination module 430 may also determine the driving habit of the user by using other ways (e.g., based on rules).

The service information pushing module 440 may be configured to push service information to the user. In some embodiments, the service information pushing module 440 may push the service information to the user according to the driving habit of the user. In some embodiments, the service information may include, but is not limited to, a non-deductible service, a vehicle cruising mileage pushing service, a shared vehicle pushing service, a vehicle sale pushing service, a navigation route pushing service, a vehicle insurance pushing service, or the like, or any combination thereof.

In some embodiments, the service information pushing module 440 may further include a non-deductible service information pushing unit 442 and a cruising mileage information pushing unit 444.

The non-deductible service information pushing unit 442 may be configured to determine a non-deductible service price of the order. For example, the non-deductible service information pushing unit 442 may determine the non-deductible service price of the order according to the driving habit of the user. In some embodiments, the non-deductible service information pushing unit 442 may determine a loss rate of the order based on information related to the loss rate. In some embodiments, the non-deductible service determination unit 442 may determine the non-deductible service price of the order based on the driving habit of the user and the loss rate of the order. The non-deductible service information pushing unit 442 may also be configured to display the determined non-deductible service price to the user.

In some embodiments, the cruising mileage information pushing unit 444 may be configured to determine the cruising mileage of the vehicle. For example, the cruising mileage information pushing unit 444 may determine the cruising mileage of the vehicle according to the driving habit of the user. In some embodiments, the cruising mileage information pushing unit 444 may determine the cruising mileage of the vehicle based on the driving habit of the user and information related to the cruising mileage. In some embodiments, the cruising mileage information pushing unit 444 may also determine the cruising mileage of the vehicle based only on the information related to the cruising mileage. In some embodiments, the cruising mileage information pushing unit 444 may determine the cruising mileage of the vehicle by using a cruising mileage prediction model 315. In some embodiments, the cruising mileage information pushing unit 444 may also be configured to display the determined cruising mileage of the vehicle to the user.

It should be understood that the system and its modules shown in FIG. 4 can be implemented in various ways. For example, in some embodiments, the system and its modules may be implemented by hardware, software, or a combination of software and hardware. Among them, the hardware part may be realized by dedicated logic. The software part can be stored in a memory and executed by an appropriate instruction execution system, such as a microprocessor or dedicated design hardware. Those skilled in the art can understand that the above-mentioned methods and systems can be implemented using computer-executable instructions and/or included in processor control codes, for example on a carrier medium such as a disk, CD or DVD-ROM, such as a read-only memory (firmware) programmable memory or a data carrier such as an optical or electronic signal carrier provides such codes. The system and its modules of the present disclosure can not only be implemented by hardware circuits such as very large-scale integrated circuits or gate arrays, semiconductors such as logic chips, transistors, etc., or programmable hardware devices such as field programmable gate arrays, programmable logic devices, etc. It may also be implemented by software executed by various types of processors, or may be implemented by a combination of the foregoing hardware circuit and software (e.g., a firmware).

It should be noted that the above description of the system for determining the driving habit of the user and pushing service information and its modules are only for convenience of description, and do not limit the present disclosure within the scope of the cited embodiments. It can be understood that for those skilled in the art, after understanding the principle of the system, it is possible to arbitrarily combine various modules, or form a subsystem to connect with other modules without departing from this principle. For example, in some embodiments, the driving record obtaining module 410, the driving feature extraction module 420, the driving habit determination module 430, and the service information obtaining module 440 disclosed in FIG. 4 may be different modules in a system, or may be one module that realizes the functions of the two or more modules mentioned above. For example, the driving feature extraction module 420 and the driving habit determination module 430 may be two modules, or one module have both driving feature extraction and driving habits determination functions. For example, each module may share a storage module, and each module may also have its own storage module. Such deformations are all within the protection scope of the present disclosure.

The beneficial effects that the embodiments of the present disclosure may include, but are not limited to: (1) enabling users with different driving habits to enjoy personalized services; (2) making the non-deductible service price more reasonable; (3) making the prediction of a vehicle cruising mileage more accurate; (4) improving the experience of the user. It should be noted that different embodiments may produce different beneficial effects. In different embodiments, the possible beneficial effects may be any one or a combination of the above, or any other beneficial effects that may be obtained.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction performing system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method for determining a driving habit of a user, the method being executed by at least one processor, the method comprising:
obtaining a historical driving record of the user;
extracting a driving feature of the user from the historical driving record; and
determining, based on the driving feature of the user, the driving habit of the user by using a trained driving habit determination model.

2. The method for determining a driving habit of a user of claim 1, wherein the driving feature of the user includes at least one of:
a car accident incurred, a violation of a traffic rule, a sharp acceleration, a sharp turn, speeding, sudden braking, an average driving speed, and a lane change.

3. A method for pushing service information, comprising:
determining a driving habit of a user according to a method for determining a driving habit of a user, wherein the method for determining a driving habit of a user includes:
obtaining a historical driving record of the user;
extracting a driving feature of the user from the historical driving record; and
determining, based on the driving feature of the user, the driving habit of the user by using a trained driving habit determination model; and
pushing the service information to the user based on the driving habit of the user.

4. The method for pushing service information of claim 3, wherein the service information includes non-deductible service information of an order, the pushing service information to the user based on the driving habit of the user includes:
pushing non-deductible service price information of the order to the user based on the driving habit of the user.

5. The method for pushing service information of claim 4, wherein the pushing non-deductible service price information of the order to the user based on the driving habit of the user includes:
determining a loss rate of the order based on information related to the loss rate;
determining the non-deductible service price of the order based on the loss rate of the order and the driving habit of the user; and
displaying the non-deductible service price of the order to the user.

6. The method for pushing service information of claim 5, wherein the information related to the loss rate includes at least one of: order information, environmental information, a historical driving route, vehicle information, traffic information, road information, and user information.

7. The method for pushing service information of claim 6, wherein the order information includes at least one of: a starting point of the order, an ending point of the order, a duration of the order, and a planned driving route of the order; and
the environmental information includes at least one of: weather, a season, an outside temperature, a time, and a type of the time.

8. The method for pushing service information of claim 5, wherein the determining the loss rate of the order based on the information related to the loss rate includes:
determining, based on the information related to the loss rate, the loss rate of the order by using a trained order loss rate prediction model.

9. The method for pushing service information of claim 3, wherein the service information includes cruising mileage information, the pushing the service information to the user based on the driving habit of the user includes:
pushing the cruising mileage information of the vehicle to the user based on the driving habit of the user.

10. The method for pushing service information of claim 9, wherein the pushing the cruising mileage information of the vehicle to the user based on the driving habit of the user includes:
determining, based on the driving habit of the user and information related to the cruising mileage, the cruising mileage information of the vehicle by using a trained cruising mileage prediction model; and
displaying the cruising mileage of the vehicle to the user.

11. The method for pushing service information of claim 10, wherein the information related to the cruising mileage includes at least one of: environmental information, vehicle information, road information, and power information; and
the environmental information includes at least one of: weather, a season, an outside temperature, a time, and a type of the time.

12. The method for pushing service information of claim 11, wherein the vehicle information includes at least one of: a vehicle age, historical charging times of the vehicle, and a service life of a vehicle accessory.

13. A system for pushing service information, comprising a driving record obtaining module, a driving feature extraction module, a driving habit determination module and a service information pushing module, wherein
the driving record obtaining module is configured to obtain a historical driving record of the user;
the driving feature extraction module is configured to extract a driving feature of the user from the historical driving record;
the driving habit determination module is configured to determine, based on the driving feature of the user, a driving habit of a user by using a trained driving habit determination model; and
the service information pushing module is configured to push service information to the user according to the driving habit of the user.

14. The system for pushing service information of claim 13, wherein the driving feature of the user includes at least one of:
a car accident incurred, a violation of a traffic rule, a sharp acceleration, a sharp turn, speeding, sudden braking, an average driving speed, and a lane change.

15. The system for pushing service information of claim 13, wherein the service information includes non-deductible service information of an order, the service information pushing module includes a non-deductible service information pushing unit;
the non-deductible service information pushing unit is configured to push the non-deductible service price information of the order to the user based on the driving habit of the user.

16. The system for pushing service information of claim 15, wherein the non-deductible service information pushing unit is configured to:
determine a loss rate of the order based on information related to the loss rate;
determine the non-deductible service price of the order based on the loss rate of the order and the driving habit of the user; and
display the non-deductible service price of the order to the user.

17. The system for pushing service information of claim 16, wherein the information related to the loss rate includes at least one of: order information, environmental information, a historical driving route, vehicle information, traffic information, road information, and user information.

18. (canceled)

19. The system for pushing service information of claim 16, wherein the non-deductible service information pushing unit is configured to:
determine, based on the information related to the loss rate, the loss rate of the order by using a trained order loss rate prediction model.

20. The system for pushing service information of claim 13, wherein the service information includes cruising mileage information, the service information pushing module includes a cruising mileage information pushing unit;
the cruising mileage information pushing unit is configured to push the cruising mileage information of the vehicle to the user based on the driving habit of the user.

21. The system for pushing service information of claim 20, wherein the cruising mileage information pushing unit is configured to:
determine, based on the driving habit of the user and information related to the cruising mileage, the cruising mileage information of the vehicle by using a trained cruising mileage prediction model; and
display the cruising mileage of the vehicle to the user.

22-26. (canceled)
